(19) United States
(12) Patent Application Publication
(10) Pub. No.: US 2015/0022473 A1
(43) Pub. Date: Jan. 22, 2015

(54) ELECTRONIC DEVICE AND METHOD FOR REMOTELY OPERATING THE ELECTRONIC DEVICE

(71) Applicants: SHENZHEN FUTAIHONG PRECISION INDUSTRY CO., LTD., Shenzhen (CN); Chiun Mai Communication Systems, Inc., New Taipei (TW)

(72) Inventor: CHENG-PING YE, Shenzhen (CN)

(21) Appl. No.: 14/337,389

(22) Filed: Jul. 22, 2014

(30) Foreign Application Priority Data
Jul. 22, 2013 (CN) 2013103076953

(51) Int. Cl. G06F 3/041

(52) U.S. Cl. CPC G06F 3/0412; G06F 2203/04108
USPC 345/173

(57) ABSTRACT

An electronic device is operated by touching on a virtual screen in front of the electronic device. The electronic device captures an image using a front camera of the electronic device when a finger of a user touches on the virtual screen. A touch event is generated to operate the electronic device according to the captured image and a reference image stored in the electronic device.

### CROSS-REFERENCE TO RELATED APPLICATIONS

This application claims priority to Chinese Patent Application No. 201310307695.3 filed on Jul. 22, 2013 in the State Intellectual Property Office of the People's Republic of China, the contents of which are incorporated by reference herein.

### FIELD

Embodiments of the present disclosure relate to remotely controlling technology, and particularly to an electronic device and a method for remotely operating the electronic device.

### BACKGROUND

A user can operate an electronic device by touching a display screen of the electronic device using a finger or a stylus. However, the finger or the stylus needs to contact the display screen of the electronic device.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 illustrates a block diagram of an example embodiment of an electronic device.

FIG. 2 shows a diagrammatic view of an example of a virtual screen in front of the electronic device.

FIG. 3 shows a diagrammatic view of an example of changing a fingertip area of a captured image to a circle.

FIG. 4 shows a diagrammatic view of an example of a radius and a center point of the captured and a radius and a center point of a reference image.

FIG. 5 is a flowchart of an example embodiment of a method for remotely operating the electronic device based on the captured image and the reference image.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented. The term “module” refers to logic embodied in computing or firmware, or to a collection of software instructions, written in a programming language, such as, Java, C, or assembly. One or more software instructions in the modules may be embedded in firmware, such as in an erasable programmable read only memory (EPROM). The modules described herein may be implemented as either software and/or computing modules and may be stored in any type of non-transitory computer-readable medium or other storage device. Some non-limiting examples of non-transitory computer-readable media include CDs, DVDs, BLU-RAY™, flash memory, and hard disk drives. The term “comprising” means “including, but not necessarily limited to”; it specifically indicates open-ended inclusion or membership in a so-described combination, group, series and the like.

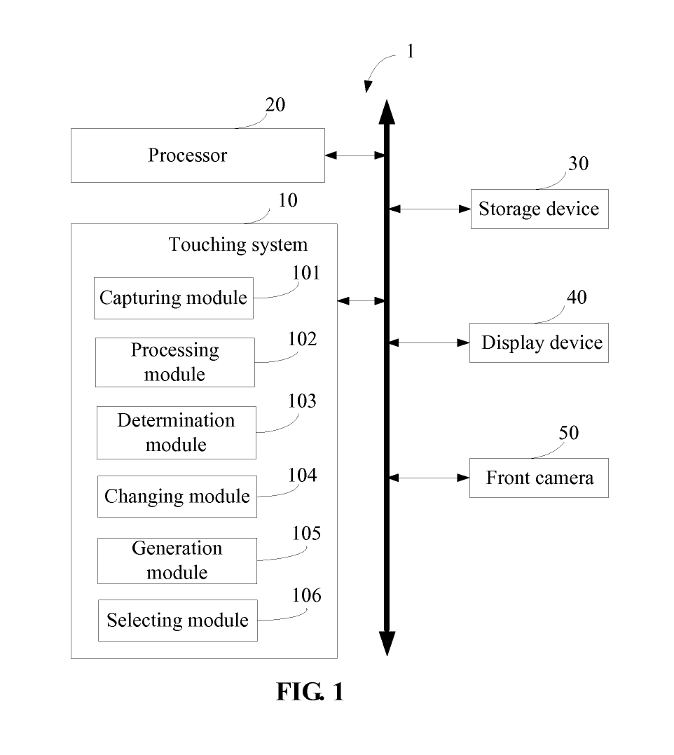

FIG. 1 illustrates a block diagram of an example embodiment of an electronic device. In the example embodiment, the electronic device 1 includes, but is not limited to, a touching system 10, at least one processor 20, a storage device 30, a display screen 40 and a front camera 50. The electronic device 1 can be, but is not limited to, mobile phones, tablet computers, personal digital assistants (PDAs), personal computers or any other electronic devices which provide functions of network connections. FIG. 1 illustrates only one example of the electronic device 1, and other examples can comprise more or fewer components that those shown in the embodiment, or have a different configuration of the various components.

In one embodiment, the storage device 30 can be an internal storage device, such as a flash memory, a random access memory (RAM) for temporary storage of information, and/or a read-only memory (ROM) for permanent storage of information. The storage device 30 can also be an external storage device, such as an external hard disk, a storage card, or a data storage medium. The at least one processor 20 can be a central processing unit (CPU), a microprocessor, or other data processor chip that performs functions of the electronic device 1.

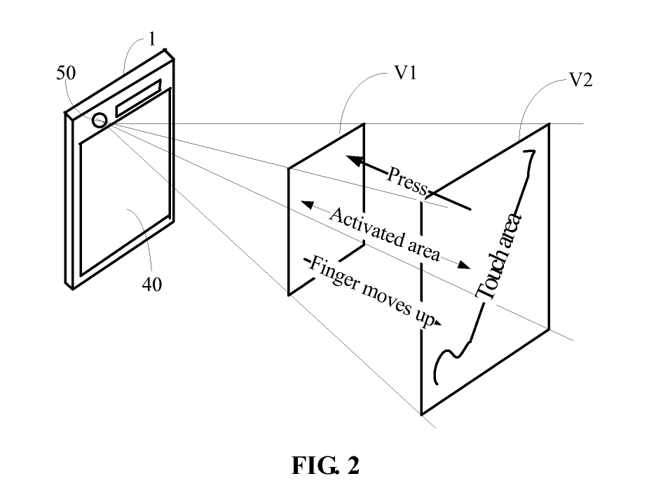

The front camera 50 generates a plurality of virtual screens in front of the display screen 40, and captures an image in front of the display screen 40 when a finger of the user touches on the virtual screens. Each virtual screen is a plane which has a touch area, and each virtual screen is parallel to the display screen 40. The touch area of each virtual screen is decided by a distance between the virtual screen and the display screen 40. That is, the longer distance between the virtual screen and the display screen 40, the bigger the touch area of the virtual screen is. In one example with respect to FIG. 2, the virtual screen V1 is closer to the display screen 40 than the virtual screen V2, the touch area of the virtual screen V1 is smaller than the touch area of the virtual screen V2. Furthermore, if a user can operate the electronic device 1 by touching the virtual screen, the virtual screen is regarded as a valid virtual screen. Valid virtual screens are predetermined between a minimum valid virtual screen and a maximum valid virtual screen. That is, if the minimum valid virtual screen and the maximum valid virtual screen are predetermined by the user, all virtual screens between the minimum valid virtual screen and the maximum valid virtual screen are regarded as valid virtual screens. For example, as shown in FIG. 2, the virtual screen V1 is predetermined as the minimum valid virtual screen and V2 is predetermined as the maximum valid virtual screen. The virtual screen is valid if the virtual screen is located between V1 and V2. In addition, the valid virtual screens can be visual or imperceptible. For better user experience, the minimum valid virtual screen and the maximum valid virtual screen are visual, so the user can touch on the valid virtual screens and operate the electronic device 1. For example, the user can touch on the valid virtual screens to start a music application installed in the electronic device 1.

The touching system 10 comprises, but is not limited to, a capturing module 101, a processing module 102, a determination module 103, a changing module 103, a generation module 105, and a selecting module 106. Modules 101-106 can comprise computerized instructions in the form of one or more computer-readable programs that can be stored in a non-transitory computer-readable medium, for example the storage device 30, and executed by the at least one processor 20 of the electronic device 1. A detailed description of the functions of the modules 101-106 is given below in reference to FIG. 1.

The capturing module 101 is configured to control the front camera 50 to capture an image when a finger of the user touches on one of the virtual screens. The image is an image of a finger (e.g., an index finger) of the user.

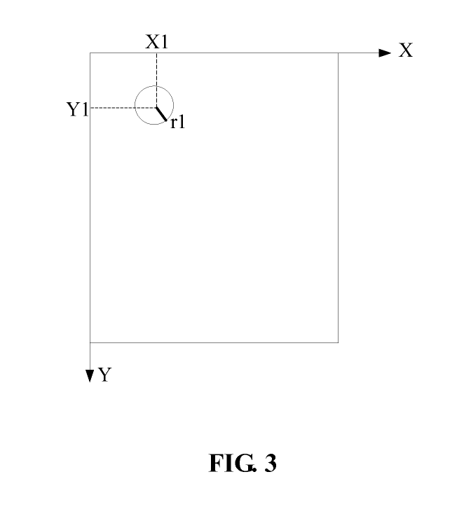

The processing module 102 is configured to extract a fingertip area from the captured image and change the fingertip area into a circle. For example, as shown in FIG. 3, the fingertip of the captured image is changed to the circle, and the coordinates of the circle is (X1, Y1) and a radius of the circle is r1.

The determination module 103 is configured to determine if the virtual screen is a valid virtual screen according to the circle. In one embodiment, the virtual screen is valid upon the condition that the radius of the circle falls within a predetermined range [R1, R2], where R1 is a minimum radius when the finger of the user touches on the minimum valid virtual screen, and R2 is a maximum radius when the finger of the user touches on the maximum valid virtual screen. In addition, the determination module 103 discards the captured the image if the virtual screen is invalid according to the circle.

The changing module 104 is configured to convert a resolution of the captured image to be same as a resolution of the display screen 40 if the virtual screen is a valid virtual screen, and obtain coordinates of a center point of the circle of the captured image on the display screen 40. The changing module 104 zooms in or out the captured image to change the resolution of the captured image. The coordinates of the circle of the captured image is converted to the coordinates of the display screen 40. The coordinates of the center point of the circle of the captured image on the virtual screen is changed to the coordinates of the center point of the circle of the captured image on the display screen 40.

The generation module 105 is configured to determine if a reference image is stored in the storage device 30, and generate a touch event according to the coordinates of the center point of the circle of the captured image on the display screen 40 and the coordinates of a center point of a circle of the reference image on the display screen 40. If the reference image is not stored in the storage device 30, the captured image is stored in the storage device 30 as a new reference image. The touch event can be used to control the electronic device 1 to a function of the electronic device 1, such as a music application installed on the electronic device 1.

In one embodiment, the touch event includes a pressing-down event, a moving event and a pressing-up event, for example.

The pressing-down event is generated upon the condition that the radius of the circle of the captured image is greater than the radius of the circle of the reference image and the coordinates of the center point of the circle of the captured image is same as the coordinates of the center point of the circle of the reference image.

The pressing-up event is generated upon the condition that the radius of the circle of the captured image is less than the radius of the circle of the reference image and the coordinates of the center point of the circle of the captured image is same as the coordinates of the center point of the circle of the reference image.

The moving event is generated upon the condition that the radius of the circle of the captured image is not equal to the radius of the circle of the reference image and the coordinates of the center point of the circle of the captured image is different from the coordinates of the center point of the circle of the reference image.

The selecting module 106 is configured to select one of the captured image and the reference image as the new reference image. In one embodiment, if the touch event is generated, the captured image is selected as the new reference image. If the touch event is not generated, the reference image is selected as the new reference image.

The determination module 103 is configured to determine if the electronic device 1 is in an idle mode or a disable mode. The electronic device is in the idle mode upon the condition that the electronic device 1 is not operated more than a predetermined time (for example, five minutes). The electronic device is in the disable mode upon the condition that the front camera 50 is turned off.

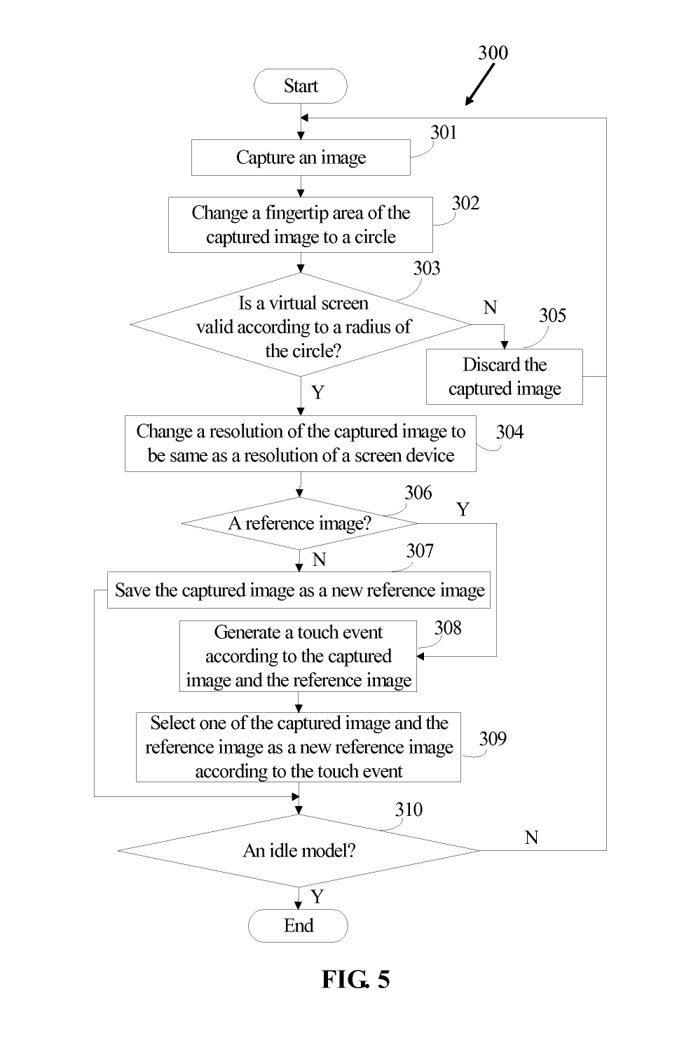

FIG. 5 illustrates a flowchart of an example embodiment of a method for remotely operating the electronic device. In an example embodiment, the method is performed by execution of computer-readable software program codes or instructions by at least one processor of the electronic device, and can touch an electronic device based on images.

Referring to FIG. 5, a flowchart is presented in accordance with an example embodiment. The method 300 is provided by way of example, as there are a variety of ways to carry out the method. The method 300 described below can be carried out using the configurations illustrated in FIGS. 1 and 5, for example, and various elements of these figures are referenced in explaining method 300. Each block shown in FIG. 5 represents one or more processes, methods, or subroutines, carried out in the method 300. Furthermore, the illustrated order of blocks is illustrative only and the order of the blocks can be changed. Additional blocks can be added or fewer blocks can be utilized without departing from this disclosure. The example method 300 can begin at block 301.

In block 301, a capturing module captures an image when a finger of a user touches on a virtual screen.

In block 302, a processing module extracts a fingertip from the captured image and change the finger area into a circle. For example, as shown in FIG. 3, the fingertip of the captured image is changed to the circle, and the coordinates of a center point of the circle on the virtual screen is (X1, Y1) and a radius of the circle is r1.

In block 303, a determination module determines if the virtual screen is a valid virtual screen according to the circle. If the virtual screen is the valid virtual screen, the procedure goes to block 304. Otherwise, if the virtual screen is not the valid virtual screen, the procedure goes to block 305, the captured image is discarded by the electronic device 1, and the procedure returns to block 301.

In block 304, a changing module converts a resolution of the captured image to be same as a resolution of a display screen, and obtains coordinates of a center point of the circle of the captured image on the display screen. For example, if the resolution of the captured image is M*N pixels, and the resolution of the display screen is A*B pixels. The resolution of the captured image is converted from M*N pixels to A*B pixels. The coordinates (X1, Y1) of the center point of the circle of the captured image on the virtual screen is changed to the coordinates (x1, y1) of the center point of the circle of the captured image on the display screen 40.

In block 306, a generation module determines if the storage device stores a reference image. If the storage device stores the reference image, the procedure goes to block 308. If the storage device does not store the reference image, the procedure goes to block 307.

In block 307, the captured image is stored in the storage device as a new reference image, then the procedure goes to block 310.

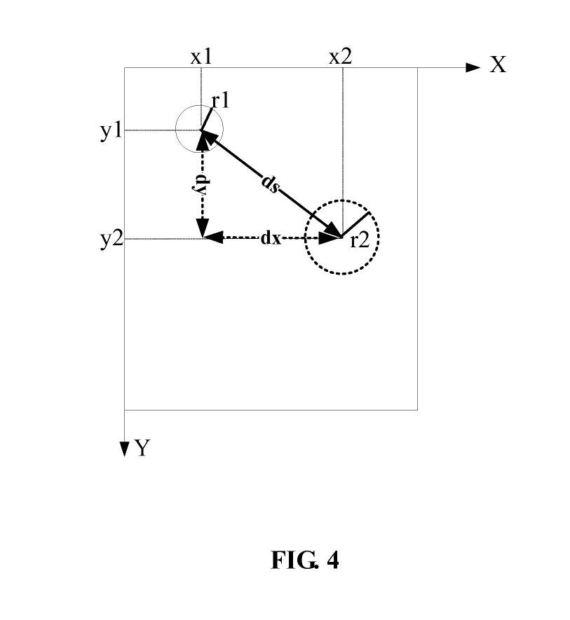

In block 308, the generation module generates a touch event according to coordinates of the center point of the circle of the captured image on the display screen and coordinates of a center point of a circle of the reference image on the display screen. In exemplary embodiment, the touch event can be used to perform a function of the electronic device, such as starting an music application installed on the electronic device. The touch event includes a pressing-down event, a moving event and a pressing-up event. As shown in FIG. 4, r1 is the radius of the circle of the captured image, and r2 is the radius of the circle of the reference image, if r2 is greater than r1 and the coordinates (x1, y1) is the same as the coordinates (x2, y2), the pressing-up event is generated. If r2 is less than r1 and the coordinates (x1, y1) is the same as the coordinates (x2, y2), the pressing-down event is generated. If r2 is not equal to r1 and the coordinates (x1, y1) is different from the coordinates (x2, y2), the moving event is generated.

In block 309, a selecting module selects one of the captured image and the reference image as the new reference image. In one embodiment, if the touch event is generated, the captured image is selected as the new reference image. If the touch event is not generated, the reference image is selected as the new reference image, and the new reference image replaces the reference image when the procedure executes from block 306 to block 308 again.

In block 310, the determination module determines if the electronic device is an idle mode. If the electronic device 1 is in the idle mode, the procedure ends. Otherwise, if the electronic device is in an idle mode, the procedure returns to block 301.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in particular the matters of shape, size and arrangement of parts within the principles of the present disclosure, up to and including the full extent established by the broad general meaning of the terms used in the claims.

What is claimed is:

1. An electronic device comprising:
at least one processor; and
a storage device that is coupled to the at least one processor and is configured to store one or more programs, which when executed by the at least one processor, cause the at least one processor to:
generate a virtual screen in front of a display screen of the electronic device;
capture an image using a front camera of the electronic device when a finger of a user touches on the virtual screen;
extract a fingertip area from the captured image and change the fingertip area into a circle;
determine if the virtual screen is a valid virtual screen according to the circle;
convert a resolution of the captured image to be same as a resolution of a display screen if the virtual screen is a valid virtual screen, and obtain coordinates of a center point of the circle of the captured image on the display screen; and
generate a touch event to operate the electronic device according to coordinates of a center point of the circle of the captured image on the display screen and coordinates of a center point of a circle of a reference image on the display screen.

2. The electronic device of claim 1, wherein the virtual screen is a plane which has a touch area, and the virtual screen is parallel to the display screen of the electronic device.

3. The electronic device of claim 1, wherein the virtual screen is the valid virtual screen upon the condition that a radius of the circle falls within a predetermined range [R1, R2], where R1 is a minimum radius when the finger of the user touches on a minimum valid virtual screen, and R2 is a maximum radius when the finger of the user touches on a maximum valid virtual screen.

4. The electronic device of claim 1, wherein touch event comprises a pressing-down event, a moving event and a pressing-up event.

5. The electronic device of claim 4, wherein the pressing-down event is generated upon the condition that the radius of the circle of the captured image is longer than the radius of the circle of the reference image and the coordinates of the center point of the circle of the captured image on the display screen is same as the coordinates of the center point of the circle of the reference image on the display screen.

6. The electronic device of claim 4, wherein the pressing-up event is generated upon the condition that the radius of the circle of the captured image is shorter than the radius of the circle of the reference image and the coordinates of the center point of the circle of the captured image on the display screen is same as the coordinates of the center point of the circle of the reference image on the display screen.

7. The electronic device of claim 4, wherein the moving event is generated upon the condition that the radius of the circle of the captured image is different from the radius of the circle of the reference image and the coordinates of the center point of the circle of the captured image on the display screen is not same as the coordinates of the center point of the circle of the reference image on the display screen.

8. A computer-based method for remotely operating an electronic device, the method comprising:
generating a virtual screen in front of a display screen of the electronic device;
capturing an image in front of the electronic device using a front camera of the electronic device when a finger of a user touches on the virtual screen;
extracting a fingertip area from the captured image and changing the fingertip area into a circle;
determining if the virtual screen is a valid virtual screen according to the circle;
converting a resolution of the captured image to be same as a resolution of a display screen if the virtual screen is a valid virtual screen;
obtaining coordinates of a center point of a circle of the captured image on the display screen;
obtaining coordinates of a center point of a circle of a reference image on the display screen, the reference image being stored in a storage device of the electronic device; and
generating a touch event to operate the electronic device according to the coordinates of the center point of the circle of the captured image on the display screen and the coordinates of a center point of the circle of the reference image on the display screen.

9. The method of claim 8, wherein the virtual screen is a plane which has a touch area, and the virtual screen is parallel to the display screen.

10. The method of claim 8, wherein the virtual screen is the valid virtual screen upon the condition that a radius falls within a predetermined range [R1, R2], wherein R1 is a minimum radius when the finger of the user touches on a minimum valid virtual screen, and R2 is a maximum radius when the finger of the user touches on a maximum valid virtual screen.

11. The method claim 8, wherein touch event comprises a pressing-down event, a moving event and a pressing-up event.

12. The method of claim 11, wherein the pressing-down event is generated upon the condition that the radius of the circle of the captured image is greater than the radius of the circle of the reference image and the coordinates of the center point of the circle of the captured image on the display screen is same as the coordinates of the center point of the circle of the reference image on the display screen.

13. The method of claim 11, wherein the pressing-up event is generated upon the condition that the radius of the circle of the captured image is less than the radius of the circle of the reference image and the coordinates of the center point of the circle of the captured image on the display screen is same as the coordinates of the center point of the circle of the reference image on the display screen.

14. The method of claim 11, wherein the moving event is generated upon the condition that the radius of the circle of the captured image is not equal to the radius of the circle of the reference image and the coordinates of the center point of the circle of the captured image on the display screen is different from the coordinates of the center point of the circle of the reference image on the display screen.

15. A non-transitory computer-readable medium having stored thereon instructions that, when executed by at least one processor of an electronic device, causing the electronic device to perform a method for remotely operating the electronic device, the method comprising:
generating a virtual screen in front of a display screen of the electronic device;
capturing an image in front of the electronic device using a front camera of the electronic device when a finger of a user touches on the virtual screen;
extracting a fingertip area from the captured image and changing the fingertip area into a circle;
determining if the virtual screen is a valid virtual screen according to the circle;
converting a resolution of the captured image to be same as a resolution of a display screen if the virtual screen is a valid virtual screen;
obtaining coordinates of a center point of a circle of the captured image on the display screen;
obtaining coordinates of a center point of a circle of a reference image on the display screen, the reference image being stored in a storage device of the electronic device; and
generating a touch event to operate the electronic device according to the coordinates of the center point of the circle of the captured image on the display screen and the coordinates of a center point of the circle of the reference image on the display screen.

16. The non-transitory computer-readable medium of claim 15, wherein the virtual screen is a plane which has a touch area, and the virtual screen is parallel to a display screen of the electronic device.

17. The non-transitory computer-readable medium of claim 15, wherein the virtual screen is the valid virtual screen upon the condition that a radius of the circle falls within a predetermined range [R1, R2], wherein R1 is a minimum radius when the finger of the user touches on a minimum valid virtual screen, and R2 is a maximum radius when the finger of the user touches on a maximum valid virtual screen.

18. The non-transitory computer-readable medium of claim 15, wherein touch event comprises a pressing-down event, and the pressing-down event is generated upon the condition that the radius of the circle of the captured image is longer than the radius of the circle of the reference image and the coordinates of the center point of the circle of the captured image on the display screen is same as the coordinates of the center point of the circle of the reference image on the display screen.

19. The non-transitory computer-readable medium of claim 15, wherein touch event comprises a pressing-up event, and the pressing-up event is generated upon the condition that the radius of the circle of the captured image is shorter than the radius of the circle of the reference image and the coordinates of the center point of the circle of the captured image on the display screen is same as the coordinates of the center point of the circle of the reference image on the display screen.

20. The non-transitory computer-readable medium of claim 15, wherein touch event comprises a moving event, and the moving event is generated upon the condition that the radius of the circle of the captured image is different from the radius of the circle of the reference image and the coordinates of the center point of the circle of the captured image on the display screen is not same as the coordinates of the center point of the circle of the reference image on the display screen.
